(19) United States
(12) Patent Application Publication
(10) Pub. No.: US 2014/0297029 A1
(43) Pub. Date: Oct. 2, 2014

(54) PARALLEL ADDRESSING METHOD

(71) Applicant: Kevin F. Peters, Corvallis, OR (US)

(72) Inventor: Kevin F. Peters, Corvallis, OR (US)

(73) Assignee: HEWLETT-PACKARD DEVELOPEMENT COMPANY, L.P., Houston, TX (US)

(21) Appl. No.: 14/353,690

(22) PCT Filed: Oct. 28, 2011
(86) PCT No.: PCT/US2011/058334

§ 371 Date: Apr. 23, 2014

(51) Int. Cl. G05B 15/02

(52) U.S. Cl. CPC G05B 15/02
USPC 700/241

(57) ABSTRACT

A parallel addressing method includes selectively addressing, according to a wrap-around addressing scheme, a first sub-set of a plurality of dispensers for parallel addressing of the first sub-set adjacent to a first area of a row; and then selectively address, according to the wrap-around addressing scheme, a second sub-set of the plurality of dispensers that is different from the first sub-set for parallel addressing of the second sub-set adjacent to a second area of the same row that is different than the first area. A computer program product and a multi-channel dispenser system are also disclosed herein.

### BACKGROUND

The present disclosure relates generally to a parallel addressing method.

Multi-channel dispensers have been used for a variety of applications, including printing micro-arrays or dispensing one or more substances into a receiving medium to perform titrations, assays, or other chemical and/or biological analyses. Multi-channel dispensers include multiple dispensing channels that dispense fluids separately. The dispensing channels may be used to add volumes of different research drugs as doses, for example, to be tested in a bioassay. The dispensing channels may also be used to dispense the same fluid from all channels in parallel, which expedites dispensing. The channels are often arranged in a straight line, and the multi-channel dispenser may be operated so that the channels translate linearly in an orthogonal straight line direction along the dispensable area of the receiving medium. When translated linearly, the multi-channel dispenser may dispense to a receiver (e.g., substrate, well plate, sample repository grid, etc.) relatively quickly, at least in part because the channels may be repositioned simultaneously and activated simultaneously to dispense to discrete positions of an entire row of the receiver. Multi-channel dispensers and their controlling computer programs offer dispensing schemes which include dispensing in simple straight-line layouts along rows or columns and repetitiously dispensing a volume equivalently at each position.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a perspective, semi-schematic view of an example of a multi-channel dispenser system including a plurality of dispensers operatively connected to a control interface;

FIG. 1B is a cross-sectional cut-away view of an example of monolithically integrated dispensers that may be used in a multi-channel dispenser system;

FIG. 1C is a perspective, semi-schematic view of an example of a cassette of dispensers that may be used in a multi-channel dispenser system;

FIG. 2 is a schematic, partially perspective view of an example of dispensers dispensing substances to discrete positions of a receiver according to an example of a wrap-around dispensing scheme;

FIG. 3A is a schematic view of an example layout of each step of an example of an addressing scheme;

FIGS. 3B and 3C are examples of an input table used to create the example layout shown in FIG. 3A, where FIG. 3B illustrates the input table that may be initially generated via a computer program product and FIG. 3C illustrated the input table after receiving additional information from a user;

FIGS. 4A through 4C are schematic views of an example layout of each step of an example of a wrap-around addressing scheme and are also partially perspective, schematic views of example dispensers dispensing substances to discrete positions of a receiver according to the wrap-around addressing scheme; and

FIG. 5 is a schematic view of an example layout of another example of a wrap-around addressing scheme.

### DETAILED DESCRIPTION

Examples of the multi-channel dispenser system disclosed herein include multiple dispensers having coordinated motion and coordinated dispense actuation, while also being fluidly separated from one another to achieve separate fluid dispensing. The multiple dispensers are able to achieve simultaneous or near simultaneous dispensing of multiple substances or of the same substance onto/into aligned positions of a receiver.

The dispensers disclosed herein may be selectively addressed, by a computer-controlled system, as sub-sets (i.e., less than all of the dispensers), even when one or more of the dispensers are aligned outside of a receiver boundary or are in between a receiver's discrete locations/positions. This may be particularly advantageous when it is desirable to create random-like layouts in a multi-dispenser mode while preserving dispensing speed. Examples of the computer program product (operable by the computer-controlled system or control interface) disclosed herein enable the creation of addressing layouts where all of the dispensers are addressed during a single addressing scheme and/or where the sub-sets of the dispensers are individually addressed during a wrap-around addressing scheme.

As used herein, a “wrap-around addressing scheme” refers to an at least two-step process that selectively electrically addresses pre-defined sub-sets of the plurality of parallel dispensers for sequential parallel addressing of the respective sub-sets adjacent to respective, desirable areas of a row. As will be described further hereinbelow, the row may be a part of a receiver, which may be a well plate, a non-media (i.e., non-paper) substrate having cavities, a media substrate (e.g., paper having discrete positions), a sample repository grid, etc. An example of the wrap-around addressing scheme may be a wrap-around dispensing scheme which includes selectively electrically addressing one sub-set of the dispensers to parallel dispense corresponding substances onto/into respective areas of a row of a receiver that are adjacent to the one sub-set, and then selectively electrically addressing a different sub-set of the dispensers to parallel dispense corresponding substances onto/into other respective areas of the row of the receiver that are adjacent to the different sub-set. An example of a useful wrap-around scheme is where a left-most sub-set of dispensers addresses receiver locations up to the right edge of the receiver, and the complementary right-most sub-set of dispensers is then used to address receiver locations up to the opposite, left-most edge of the receiver.

“Parallel dispensing” may involve the activation of each of the parallel dispensers, activation of a sub-set of adjacent parallel dispensers, or activation of some, but not all, of a sub-set of adjacent parallel dispensers. In the latter example, the non-actuated dispenser(s) will not dispense any substance, leaving non-filled position(s) on the receiver. As such, parallel dispensing may involve dispensing a substance from one dispenser while simultaneously not dispensing anything from another dispenser. Parallel dispensing may also include addressing some or all of the dispensers that are included in an array including rows and columns.

The examples disclosed herein refer to row(s), for example, of a layout and of a receiver. It is to be understood that the example schemes may be applied to columns of the layout and the receiver, depending, at least in part, on how the receiver is positioned with respect to the dispensers of the multi-channel dispenser system. In some example, as will be described further hereinbelow, the dispensers are arranged in a two-dimensional array, and thus the schemes may be applied to both rows and columns simultaneously.

The terms “first”, “second”, “third”, etc. may be used herein to distinguish one component (e.g., one row) from another component (e.g., another row). It is to be understood that these terms may be utilized to facilitate understanding, but are not meant to impose any particular order on the components being described. The examples disclosed herein may also refer to particular discrete positions in a layout or on a receiver using a modified matrix notation (i, j), where “i” is the numerical index of the row and “j” is the numerical index of the column.

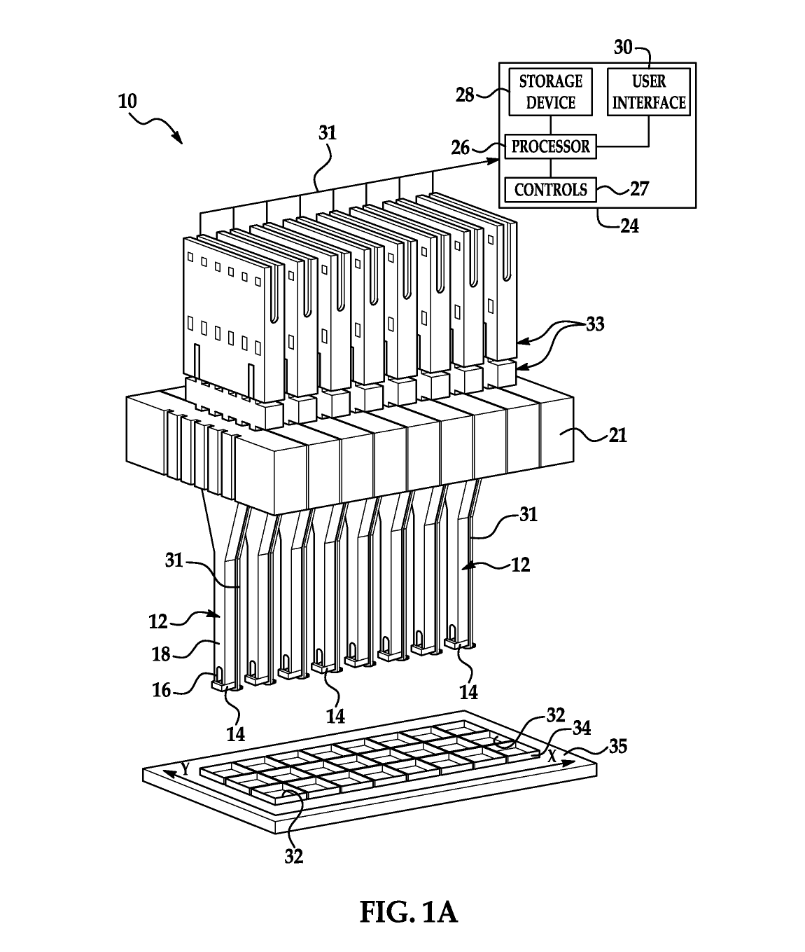

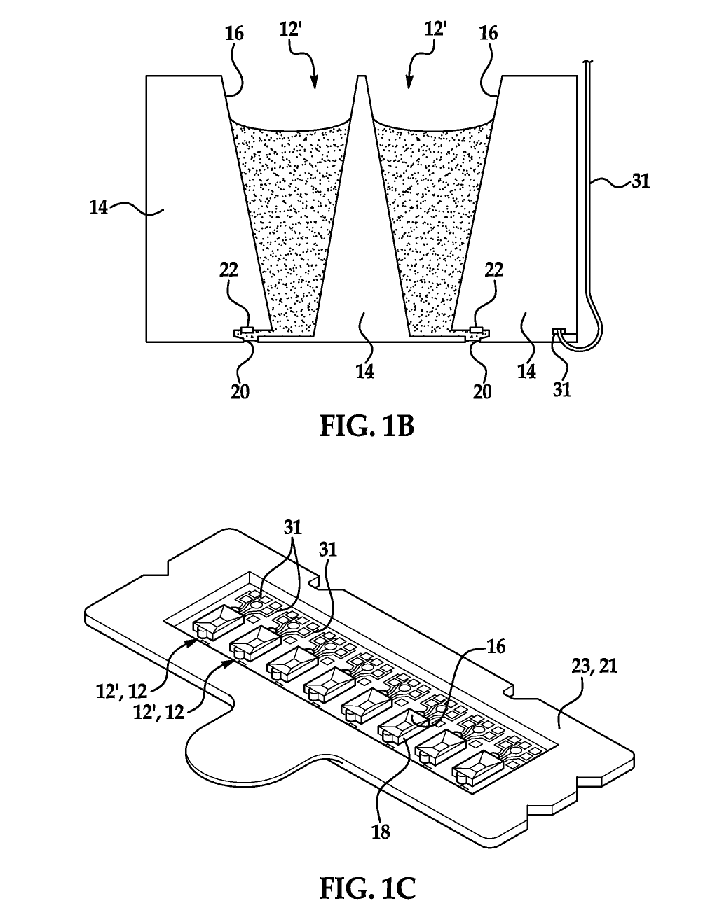

Referring now to FIG. 1A, an example of some of the components of the multi-channel dispenser system 10 is depicted. The multi-channel dispenser system 10 includes at least a plurality of individual dispensers 12 or 12′ (shown in FIG. 1B) that are conjoined and aligned in a substantially linear, parallel fashion (as shown in FIGS. 1A-1C) or as an array. The dispensers 12 may be analog dispensers that modulate the delivered volume via a variable or time-gated pressure, displacement, nozzle restriction, valve opening, or fluid attraction/repulsion/deflection. The dispensers 12 may also be digital dispensers that are capable of delivering variable quantities of fluid as a multitude of small, like-sized droplets that are dispensed onto a receiver 34 (discussed further hereinbelow). Examples of suitable dispensers 12 or 12′ include jet dispensers (e.g., thermal jet dispensers, piezo jet dispensers, piezo-capillary jet dispensers), acoustic dispensers (e.g., acoustic dispensers by EDC and Labcyte), syringe-based dispensers, and tips or pipettes for aspirate-and-dispense functions (e.g., GILSON® tips and pipettes, Hamilton pipettes, Mosquito pipettes, etc.).

The multi-channel dispenser system 10 may include any number of dispensers 12 (or 12′). In an example, the number of dispensers 12 (or 12′) is 8. In some examples, the number of dispensers 12 (or 12′) may correspond to a standard number of discrete positions 32 in a row, column, or area of a standard receiver 34. Standard numbers of discrete positions 32 may include, for example, 4, 6, 8, 12, 16, 24, 32, 48, 64, 96, 384, and 1536.

The various dispensers 12 of the multi-channel dispenser system 10 are conjoined. As used herein, the term “conjoined” means that the dispensers 12 are coupled together in some manner so that they can be moved as a single entity. In an example, the dispensers 12 may be conjoined by assembling the dispenser components together (e.g., a multi-channel autopipettor). As an example, the dispensers 12 themselves are discrete, separate entities (e.g., as shown in FIG. 1A) that are assembled together using a carriage 21. In another example, the dispensers 12′ may be formed as a monolithic device (e.g., a jetting chip with parallel fluid channels and associated nozzles or an array of fluid channels and associated nozzles formed therein). An example of a monolithic device is shown and described in FIG. 1B. In still another example, the dispensers 12 may be partially monolithic and partially assembled (e.g., multiple fluid channels and nozzles may be monolithically formed in a die (as shown in FIG. 1B) and may have an attached fluid channel extender(s) to increase the dimensions of the fluid channels). Such a partially monolithic and partially assembled device is shown in FIG. 1C. It is to be understood that the monolithically integrated multi-channel dispensers (FIG. 1B) or the partially monolithic and partially assembled multi-channel dispensers (FIG. 1C) may be assembled as an array.

In the example shown in FIG. 1A, each dispenser 12 includes a die 14. An example of the die 14 is a chip having microelectromechanical system (MEMS) structures embedded thereon and/or therein. The die 14 may define, or may be in fluid communication with a fluid channel 16 that receives the desirable fluid/substance to be dispensed from the dispenser 12. In the example shown in FIG. 1A, the die 14 is also attached to a fluid channel extender 18 that has one or more slots formed therein that can receive fluid from a fluid source. Other examples of the fluid channel extender 18 do not have slots formed therein. The interior of the fluid channel extender 18 is in fluid communication with the fluid channel 16 and actually expands the dimensions of the fluid channel 16. Fluid is delivered from the channel 16 to nozzles (not shown in FIG. 1A) via capillary action or some other fluid priming action.

It is to be understood that when tips, pipettes, or the like are utilized as the dispenser 12, a die 14 may not be utilized. Rather, in these examples, a housing may define the fluid channel 16.

Another example of the die 14 is shown in FIG. 1B. More particularly, FIG. 1B illustrates monolithically integrated dispensers 12′ including a single die 14, which may be made up of one or more layers. The single die 14 has multiple fluid channels 16 formed therein, each of which corresponds to one of the dispensers 12′. Each fluid channel 16 is also associated with its own nozzle(s) 20. In the examples disclosed herein (e.g., FIGS. 1A through 1C), the nozzle(s) 20 is/are defined in the die 14 and is/are in fluid communication with the fluid channel 16 for dispensing the fluid/substance. It is to be understood that when the dispenser 12 or monolithically integrated dispensers 12′ do not include a die 14 (e.g., a tip, a pipette, etc.), the nozzle(s) may be formed in the housing that defines the fluid channel 16. The number of nozzles may vary depending upon the dispenser 12 or dispensers 12′. Some dispensers 12 or 12′ are single-nozzle dispensers and other dispensers 12 or 12′ are multi-nozzle dispensers. For example, a syringe or plastic tip dispenser may have a single nozzle. For another example, a jet dispenser may have anywhere from 1 nozzle to 100 nozzles per fluid channel 16. An example of a multi-nozzle dispenser 12, 12′ has 22 nozzles per fluid channel 16.

As shown in FIG. 1B, each of the monolithically integrated dispensers 12′ includes an actuator 22 associated with the fluid channel 16. In the example shown in FIG. 1A, it is to be understood that each individual dispenser 12 may, in some examples, have a die 14 with an actuator 22 operatively positioned therein. In any of the examples disclosed herein, the actuator 22 may be aligned with one or more nozzles 20 so that when actuated, droplets of a predetermined volume may be dispensed from the fluid channel 16 of the dispenser 12 or the monolithically integrated dispensers 12′. The actuator 22 of a pipette or tip type dispenser may be an electrically actuated fluid displacement mechanism that forces the substance/fluid out of the nozzle(s) 20.

FIG. 1C depicts a cassette 23 or carriage 21 with eight dispensers 12, 12′ that each include a die 14 (positioned beneath the cassette 23 and thus not shown) with attached fluid extenders 18 and attached addressing circuitry 31 (electrical leads and electrical contact pads). In this example, each die 14 may be part of a separate dispenser 12 (e.g., similar to the dies 14 shown in FIG. 1A), or a single die 14 may define multiple fluid channels 16 and monolithically integrated dispensers 12′.

As will be discussed further hereinbelow, the monolithically integrated dispensers 12′ of FIG. 1B and the dispensers 12 or 12′ that are part of the cassette 23 of FIG. 1C are operatively connected to addressing circuitry 31 (e.g., electrical pins, bond pads, traces, etc.) that is designed to also operatively connect to a processor of a control interface that is used to control addressing and dispensing. As such, the examples of FIG. 1B and 1C may be integrated into a multi-channel dispenser system. In the examples shown in both FIGS. 1B and 1C, the addressing circuitry 31 is configured so that each dispenser 12′, 12 is individually addressable by a processor.

In the examples shown in FIGS. 1A through 1C, fluid may be introduced into the fluid channels 16 via another fluid dispenser (e.g., a pipette), a fluid source (e.g., where fluid is drawn into the channel 16), or a reservoir (e.g., which delivers the fluid/substance on command to the fluid channel(s) 16 in response to signals from a processor.

Referring back to FIG. 1A (but also referencing FIGS. 1B and 1C), each of the dispensers 12 (or the monolithically integrated dispensers 12′) is connected to a control interface 24, which includes at least a processor 26, a storage device 28, and a user interface 30. It is to be understood that the dispensers 12, 12′ may be permanently attached or removably attached to the processor 26 (e.g., the cassette 23 and its dispensers 12 are removably attached). The processor 26 may include the hardware architecture for retrieving executable code (i.e., computer readable instructions) from the data storage device 28 and executing the executable code. The executable code may, when executed by the processor 26, cause the processor 26 to implement at least the functionality of selecting some or all of the dispensers 12, 12′ according to a single addressing scheme or a wrap-around addressing scheme. In the course of executing code, the processor 26 may receive input from and provide output to a number of other hardware units (e.g., user interface 30). The processor 26 may also deliver actuation power to the selected dispensers 12, 12′ and may cause the desired volumes to be dispensed.

The data storage device 28 may store data, such as a layout (including, for example, dosage data) generated using the computer program product disclosed herein. In an example, the data storage device 28 saves the layouts in the form of a database for easy retrieval when the computer program product is accessed by a user. The data storage device 28 may include various types of memory modules, including volatile and nonvolatile memory. As an example, the data storage device 20 may include Random Access Memory (RAM), Read Only Memory (ROM), and Hard Disk Drive (HDD) memory. It is believed that other types of memory may also be used. In some instances, different types of memory in the data storage device 28 may be used for different data storage needs. For example, the processor 26 may boot from Read Only Memory (ROM), maintain nonvolatile storage in the Hard Disk Drive (HDD) memory, and execute program code stored in Random Access Memory (RAM). Generally, the data storage device 28 may be a non-transitory, tangible computer readable storage medium. For example, the data storage device 28 may be an electronic, magnetic, optical, electromagnetic, infrared, or semiconductor system, apparatus, or device, or any suitable combination thereof. More specific examples of the computer readable storage medium may include, for example, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination thereof.

The processor 26, in conjunction with addressing circuitry 31, operatively and individually controls each dispenser 12, 12′ such that a predetermined volume of a fluid/substance may be dispensed into or onto one or more positions 32 on the receiver 34. If a reservoir is fluidly connected to deliver fluid to a fluid channel 16 associated with the dispenser 12, 12′, it is to be understood that the processor 26, in conjunction with the addressing circuitry 31, also controls the amount of fluid/substance that is delivered from the reservoir to the fluid channel 16. In many examples however, the fluid channels 16 will be manually fillable via a user of the system 10.

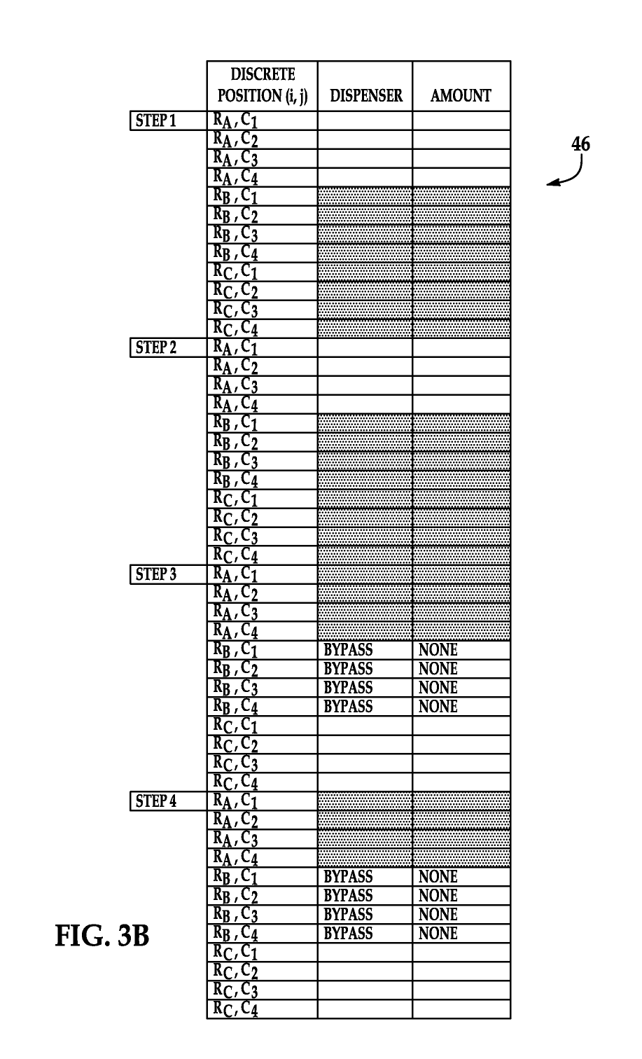

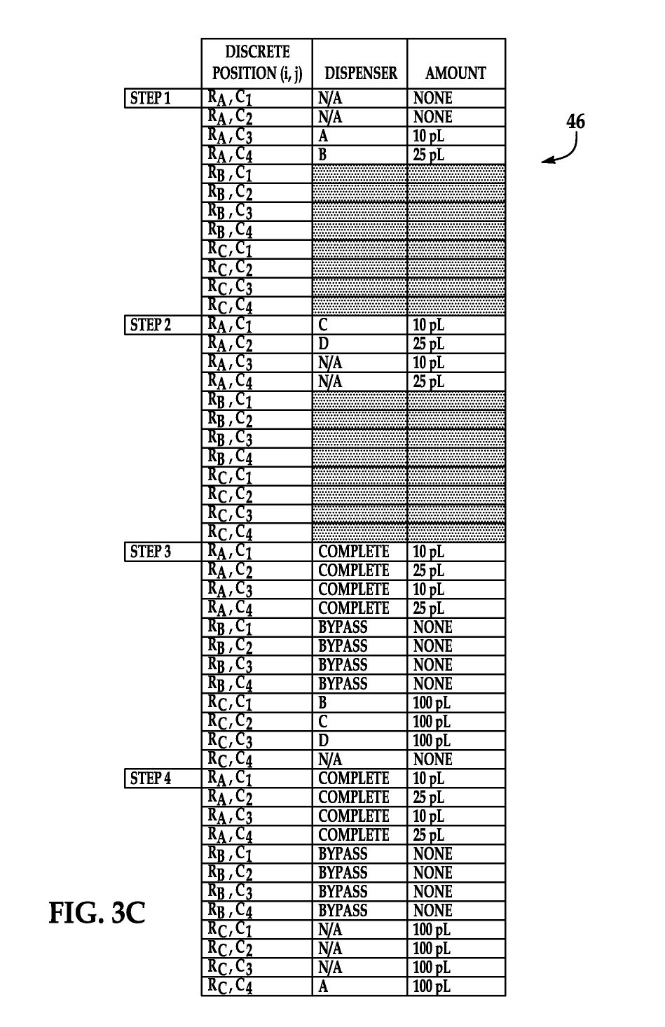

The addressing circuitry 31 may include electrical interconnect members, conductive traces, bond pads, electrical pins, and/or the like. The addressing circuitry 31 operatively connects, for example, the actuators 22 to the processor 26 such that the processor 26 controls the electronics throughout the multi-channel dispenser system 10. The addressing circuitry 31 may, in some instances, be housed in an electrical housing 33 (FIG. 1A), and/or integrated into the die 14 (FIG. 1B), and/or formed directly on a surface of the cassette 23 (FIG. 1C). The multi-channel dispenser system 10 shown in FIG. 1A also includes the receiver 34. As mentioned above, the receiver 34 may be any media or non-media substrate having discrete positions 32 (e.g., cavities) for receiving substances. Examples of the receiver 34 will be discussed further in reference to FIGS. 3-5. FIG. 1A also shows a transport stage 35 that supports the receiver 34 and may be used for receiver 34/dispenser 12, 12′ positioning. It is to be understood that the system 10 includes controls 27 that are utilized to position the receiver 34 and/or conjoined dispensers 12, 12′ for each step of an addressing scheme.

It is to be understood that in any of the examples disclosed herein, the dispensers 12, 12′ may be arranged in a two-dimensional array including any number of dispensers 12, 12′ in any number of rows and any number of dispensers 12, 12′ in any number of columns. As an example, an array of dispensers 12, 12′ may be a 9×12 array. A two-dimensional array of dispensers 12, 12′ may be used to dispense substance(s) in discrete positions of rows and/or columns of a receiver 34 simultaneously or near-simultaneously. A wrap-around scheme using a two-dimensional array of dispensers 12, 12′ may involve two sub-sets of dispensers 12, 12′ delineated as sections along a row and may also involve two additional sub-sets of dispensers 12, 12′ delineated as sections along a column. As such, some examples of this wrap-around scheme involve an at least four-step process. This type of wrap-around scheme may be used to wrap around a corner of a receiver 34, as opposed to an edge of the receiver 34.

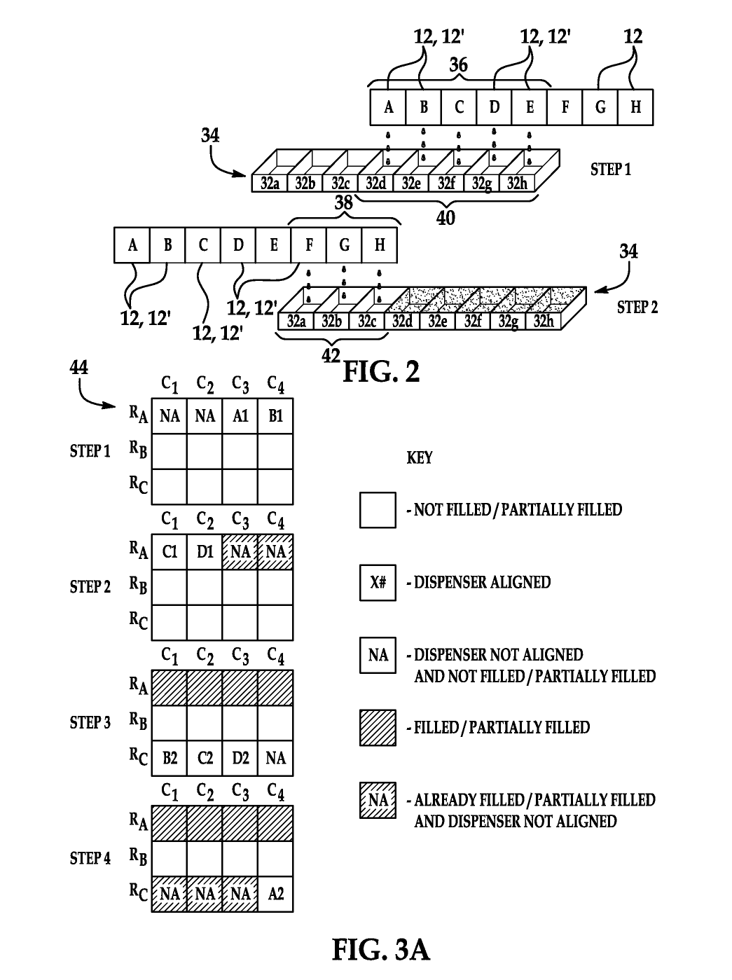

As mentioned above, the conjoined dispensers 12, 12′ may be selectively addressed according to a wrap-around addressing scheme. An example of the wrap-around addressing scheme as a two-step process is shown in FIG. 2.

It is to be understood that prior to implementing a wrap-around addressing scheme using the multi-channel dispenser system 10, the scheme may be created using the control interface 24 or by using another computing device (not shown) that is operatively connected to the processor 26, which executes the computer readable instructions of the computer program product disclosed herein. The computing device may be any device that is capable of being wired or wirelessly connected to the processor 26, including, for example, desktop computers, laptop computers, cell/smart phones, personal digital assistants (PDAs), or the like. The computing device provides an interface for a user to interact with and utilize the computer program product to create, for example, a layout corresponding to a desired wrap-around addressing scheme. Examples of layouts that may be generated using the computer program product will be further described in reference to FIGS. 3-5.

In the example of FIG. 2, eight dispensers 12, 12′ are shown and are labeled A-H. A receiver 34 is positioned with respect to the dispensers 12, 12′and includes eight discrete positions labeled 32ₐ-32ₕ. The dispensers 12, 12′and the receiver 34 are configured such that either the dispensers 12, 12′, A-H or the receiver 34 is movable in order to align at least some of the dispensers 12, 12′ A-H with at least some of the discrete positions 32ₐ-32ₕ of the receiver 34. As mentioned above, the receiver 34 may be a substrate, a well plate (e.g., a microplate, a filter plate, a solid phase extraction plate, etc.), a sample repository grid, or the like, and the discrete positions 32ₐ-32ₕ may be isolated slots, wells, cavities, prepared areas, or some other repository capable of separately receiving and holding a fluid/substance therein. In an example, the substrate is a media substrate, e.g., a paper-like test strip. In another example, the substrate is a non-media substrate (i.e., a substrate other than paper, coated paper, etc.). The non-media substrate includes some isolated positions (e.g., depressions, which may be similar to small test tubes) that can each receive a substance therein. The substance(s) deposited into each of the substrate positions may be used in titration, assaying, cell growth, and other biological and/or chemical applications.

At the first step of this example of the wrap-around addressing scheme, the dispensers 12, 12′ are moved into a position that enables a particular sub-set 36 of the dispensers 12, 12′, A-E to align with a particular sub-set 40 of the discrete positions 32_{d}-32ₕ of the receiver 34. Alignment in this example means that the sub-set 36 of dispensers 12, 12′, A-E is positioned so that a fluid/substance associated with each of the dispensers 12, 12′, A-E is capable of being dispensed from each of the dispensers 12, 12′, A-E into a desired one of the discrete position 32_{d}-32ₕ. Once in alignment, the dispensers 12, 12′, A-E are actuated by the processor 26 and addressing circuitry 31. In the example shown in FIG. 2, the dispensers 12, 12′, A-E parallel dispense a fluid/substance into a respective one of the discrete positions 32_{d}-32ₕ of the receiver 34 in response to dispense actuation. In general, the dispensing may be parallel and instantaneous, or in rapid succession. Furthermore, in some instances, movement between or during the dispensing events may be desired in order to increase throughput and/or maintain alignment of each dispenser 12, 12′, A-H with its respective discrete position 32ₐ-32ₕ. The selection of the sub-set 36 of the dispensers 12, 12′, A-E to be actuated during the first step and the selection of the sub-set 40 of the discrete positions 32_{d}-32ₕ to be aligned with the sub-set 36 of dispensers 12, 12′, A-E during the first step occur prior to initiation of the wrap-around addressing scheme and via the computer program product.

During the first step of this example wrap-around addressing scheme, the dispensers 12, 12′, F-H are not in registry/alignment with the discrete positions 32ₐ-32ₕ of the receiver 34. As such, at the first step of this example wrap-around addressing scheme, the dispensers 12, F-H are not actuated via the processor 26.

Once the desirable amount is dispensed from each of the dispensers 12, 12′, A-E in the sub-set 36, actuation is terminated. After the first step is complete, the discrete positions 32_{d}-32ₕ of the receiver 34 are filled with a desirable amount of a desirable fluid/substance, and the processor 26 then commands the dispensers 12, 12′ to perform the second step according to the wrap-around addressing scheme.

At the second step of this example of the wrap-around addressing scheme, the dispensers 12, 12′ are again selectively actuated. At the second step, the dispensers 12, A-H are moved into another position that enables a different sub-set 38 of the dispensers 12, 12′, F-H to align with a different sub-set 42 of the discrete positions 32ₐ-32_{c} of the receiver 34. Alignment in this example means that the sub-set 38 of dispensers 12, 12′, F-H is positioned so that a fluid/substance associated with each of the dispensers 12, 12′, F-H is capable of being dispensed from each of the dispensers 12, 12′, F-H into a desired one of the discrete position 32ₐ-32_{c}. Once in alignment, the dispensers 12, 12′, F-H are actuated by the processor 26 and addressing circuitry 31. In the example shown in FIG. 2, the dispensers 12, 12′, F-H parallel dispense a fluid/substance into a respective one of the discrete positions 32ₐ-32_{c} of the receiver 34 in response to dispense actuation. The selection of the sub-set 38 of the dispensers 12, 12′, F-H to be actuated during the second step and the selection of the sub-set 42 of the discrete positions 32ₐ-32_{c} to be aligned with the sub-set 38 of dispensers 12, 12′, F-H during the second step occur prior to initiation of the wrap-around addressing scheme and via the computer program product.

During the second step of this example wrap-around addressing scheme, the dispensers 12, 12′, A-E are not in registry/alignment with the discrete positions 32ₐ-32ₕ of the receiver 34. As such, at the second step of this example wrap-around addressing scheme, the dispensers 12, A-E are not actuated via the processor 26.

As shown in FIG. 2, from the first step to the second step, the dispensers 12, 12′, A-H dispense fluid to discrete positions 32ₐ-32ₕ at one end of a row of the receiver 34 and then dispense fluid to discrete positions 32ₐ-32ₕ at another end of the same row of the receiver 34. It is to be understood that the layout for the wrap-around dispensing scheme shown in FIG. 2 could be reversed so that discrete positions 32ₐ-32_{c} would be filled first with fluid/substances from dispensers 12, 12′, F-H and then discrete positions 32_{d}-32ₕ would be filled subsequently with fluids/substances from dispensers 12, 12′, A-E. It is to be further understood that since the dispenser 12, 12′, A-H are positioned in a fixed order (e.g., A, B, C, D, E, F, G, H), the fluids/substances will be dispensed such that the substance from A is next to the substance from B, etc., even if the order continues from the end of the row to the beginning of the same row. For example, in FIG. 2, the fluid/substance from dispenser 12, 12′, E is considered to be next to the fluid/substance dispensed from dispenser 12, 12′, F because the fluid/substance from dispenser 12, 12′, E is dispensed into the last discrete position 32ₕ in the row and the fluid/substance from dispenser 12, 12′, F is dispensed into the first discrete position 32ₐ in the same row. As mentioned above, the wrap-around addressing scheme may also wrap across the first and last positions of a column, which may be particularly desirable when the dispensers 12, 12′ are arrayed in two dimensions. There may also be instances where the order of fluids/substances does not correspond with the order of the dispensers 12, 12′, for example, when one or more individual dispensers 12, 12′ of the sub-set 36, 38 is not actuated while the remainder of the individual dispensers 12, 12′ within the sub-set 36, 38 are actuated. Still further, there may be instances where the dispensers 12, 12′ and discrete positions 32 do not exactly align. In such instances, the translation stage 35 may be used to adjust positions between dispenses.

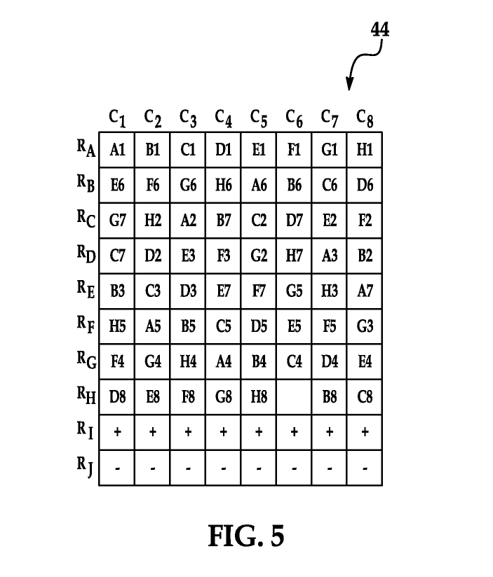

In the example shown in FIG. 2, each dispenser 12, 12′, A-H selectively dispenses a different fluid/substance into a respective discrete position 32ₐ-32ₕ of the receiver 34 according to the wrap-around addressing scheme. It is to be understood that the amount of fluid/substance dispensed will depend, at least in part, upon the dispenser 12, 12′ that is used and layout that is created. Each dispenser 12, 12′ may be programmed to dispense a different volume. The volumes may vary independently among dispensers 12, 12′ ranging from zero up to a maximum volume that is dictated, at least in part for example, by the volume of the discrete position 32ₐ-32ₕ. The ability to vary the volume in any desirable manner allows for dispensing a variable or non-monotonic dosage sequence, which will be further described in reference to FIG. 5.

The volume that may be dispensed may be very small/minute. As defined herein, the terms “very small volume” and “minute volume” both refer to a volume ranging from about 10 femtoliters (fL) or a fraction thereof to about 10 microliters /(μL) of fluid, and in some examples, up to about 50 μL of fluid. In an example, pipette tips are used to dispense a volume ranging from 0.05 μL to about 50 μL. In another example, the individual dispensed volumes range from 1 picoliter (μL) to 5 μL, and these relatively large volumes are made up of numerous picoliter droplets. In still another example, the individual volume of dispensed drops ranges from about 1 μL to about 300 μL.

While the wrap-around addressing scheme shown in FIG. 2 is relatively simple, it is to be understood that any number of the individual dispensers 12, 12′ may dispense to any single discrete position 32 by employing a suitable wrap-around scheme(s) that aligns and actuates each desired dispenser 12, 12′ at the desired discrete positions 32. This functionality is important for efficiently combining two or more chemicals, for example. As such, it is to be understood that multiple wrap-around schemes may be performed within the same row of a receiver 34. Any number of wrap-around schemes may be performed sequentially to dispense different fluid(s)/substance(s) into the discrete positions 32ₐ-32ₕ of the same row. These examples allow elaborate mixtures to be achieved at very high throughput. It is believed that the wrap-around capability disclosed herein may improve research quality and/or speed. For example, the examples disclosed herein enable one to perform serial dilution for better dose-response experiments by aspirating fluids from a first row of a well plate and then dispensing them via a wrap-around scheme to two sub-sets of the discrete positions 32ₐ-32ₕ in a second row, and so on, iteratively to subsequent rows, for a complete serial-dilution work flow. This results in a deliberately disordered layout of drugs titrated as doses in a well plate. In another example, a deliberately disordered layout of drugs titrated as doses in a well plate may be generated by repeated wrap-around schemes performed by digital multi-channel jet dispensers dispensing drugs at doses corresponding to a titration series.

In FIG. 2, the discrete positions are labeled 32ₐ-32ₕ. In the examples discussed in reference to FIGS. 3-5, the receiver 34 includes at least two rows. As such, the discrete positions 32 in these examples are identified by their row position (Rₓ), where x is the name of the row (e.g., row A, B, C, etc.) and their column position (C_{y}), where y is the number of the column (e.g., column 1, 2, 3, 4, etc.). Therefore, for FIGS. 3-5, the notation 32ₐ-32ₕ for the discrete positions of the receiver 34 will not be utilized.

Referring now to FIG. 3A, an example of a layout 44 for an addressing scheme that may be created using the computer program product disclosed herein is shown. The computer program product is programmed to offer multiple layout choices to a user. The user may input these choices via, for example, an input device, such as a keyboard or keypad, mouse, touchscreen, etc. The layout choices include the size of the receiver 34 to be used, the type of addressing scheme to be used (e.g., single, wrap-around, bypass) in each row (or column) of the receiver 34, the dispensers 12, 12′ that will be part of a particular sub-set 36, 38, the discrete positions 32 that will be part of a particular sub-set 40, 42, and the amount of fluid to be dispensed from each dispenser 12, 12′ into each discrete position 32 of the receiver 34. The user may input at least some of his/her selections via an input table 46, an example of which is shown in FIGS. 3B andb 3C. The computer program product then takes the information from the completed input table (FIG. 3C) and creates the layout 44, an example of which is shown in FIG. 3A.

To discuss the creation of a layout 44, FIGS. 3A-3C will now be discussed together. In this example, while not shown, it is to be understood that the multi-channel dispenser system 10 includes four parallel dispensers 12, 12′ A-D and the receiver 34 includes 3 rows R_{A}, R_{B}, R_{C} and 4 columns C₁, C₂, C₃, C₄ for a total of 12 discrete positions ((R_{A}, C₁), (R_{A}, C₂) . . . (R_{B}, C₁) . . . (R_{C}, C_{C1}) . . . (R_{C}, C₄)).

Upon initiating the generation of a layout 44, the user may be prompted by the computer program product to input general information, such as the number of rows and columns in his/her receiver 34, and the type of scheme he/she wishes to use for each row or column (depending upon the orientation of the dispensers 12, 12′ with respect to the receiver 34). From this information, the computer program product determines the number of discrete positions in the user's receiver 34 and the number of steps that will be needed to fulfill the requested addressing scheme. For example, the user may input that his/her receiver has 3 rows R_{A}, R_{B}, R_{C} and 4 columns C₁, C₂, C₃, C₄, and may request that row R_{A} be filled via a first wrap-around addressing scheme, that row R_{B} be bypassed, and that row R_{C} be filled according to a second wrap-around addressing scheme that is different than the wrap-around addressing scheme for filling row R_{A}. The computer program product receives the input information and, via the processor executing the computer readable instructions, generates an input table 46 similar to the one shown in FIG. 3B.

The input table 46 shown in FIG. 3B reflects the initial information and requests of the user. Since the user requests that row R_{A} be filled via a wrap-around addressing scheme, the computer program product generates two steps (e.g., Step 1 and Step 2) where the user can input information that will reflect how he/she would like the wrap-around address scheme to be performed. In this example, the fields that are not involved in a particular step may be blocked out or non-fillable (e.g., the shaded fields in FIG. 3B) so that a user does not inadvertently input data that is not in accordance with his/her original request. Alternatively, if all fields remain fillable and a user inadvertently inputs data into a field that is not in accordance with his/her original request, the user may be issued a warning or may be asked if he/she wishes to change his/her original addressing scheme. For example, in steps 1 and 2, the dispenser and amount fields for discrete positions in rows R_{B} and R_{C} are non-fillable because these rows are not involved in the addressing scheme during these steps.

When a user requests to bypass a row (i.e., does not want any of the discrete positions to be filled), the computer program product may simply acknowledge this request by filling in the bypass information in the next step of the input table 46. This is shown in FIG. 3B. Alternatively, the computer program product may be programmed to actually create a step for the bypass.

Since the user also requests that row R_{C} be filled via a wrap-around addressing scheme, the computer program product generates two additional steps (e.g., Step 3 and Step 4) where the user can input information that will reflect how he/she would like the second wrap-around address scheme to be performed. These steps illustrate the bypass request in any fields that correspond with row R_{B}. Similarly, in steps 3 and 4, the dispenser and amount fields for discrete positions in row R_{A} are non-fillable because this row is not involved in the addressing scheme during these steps.

Upon receiving the input table 46 shown in FIG. 3B via his/her computing device interface 30 (e.g., monitor, screen, etc.), the user may input the desirable dispenser and amount information for each discrete position of the receiver 34. The user may create any desirable wrap-around scheme by inputting the desirable dispenser (e.g., A-D) that is to be used to fill a corresponding one of the discrete positions. The user's selections may be limited, for example, by the configuration of the dispensers 12, 12′, A-D. The computer program product may be programmed to recognize the configuration of the dispensers 12, 12′ to which it is operatively connected (via processor 26), and thus can recognize when a requested addressing scheme is not compatible with the dispensers 12, 12′. For example, if the user requests a two-step wrap-around scheme, but then inputs that dispenser 12, 12′, A is to dispense in discrete position (R_{A}, CO, dispenser 12, 12′, B is to dispense in discrete position (R_{A}, C₃), and dispenser 12, 12′, C is to dispense in discrete position (R_{A}, C₂), the computer program product would recognize that this sequence does not follow the parallel order of the dispensers (e.g., A, B, C, D) and thus such an addressing scheme would require additional steps.

The computer program product may either deny this attempted data entry or may provide a warning to the user that the input information requires additional steps in both the programming and the dispensing execution. In an example, the warning may ask if the user wishes to change his/her original addressing scheme or modify the input data entry. In another example, warnings may inform the user that a dispense volume(s) is non-compliant with allowances, such as a volume limitation of the receiver 34 or the dispenser 12, 12′. For example, if an entered amount exceeds some set maximum for the dispenser 12, 12′ or the receiver 34, the computer program product may either deny this attempted data entry or may provide a warning to the user that the input information is outside of an allowed amount. The warning in this example may insist that the user modify the input data entry. Alternatively, in this example, the warning and the processor 26 may indicate that the non-compliant volumes are being adjusted to within allowances of the system 10. Other alarms/warnings are within the purview of this disclosure.

An example of the input table 46 after the user has input the desirable information is shown in FIG. 3C. In this example, the user has requested that the first addressing scheme initially dispense to row R_{A} by first dispensing 10 μL of a corresponding fluid/substance from dispenser A, 12, 12′ into discrete position (R_{A}, C₃) while simultaneously dispensing 25 μL of a corresponding fluid/substance from dispenser B, 12, 12′ into discrete position (R_{A}, C₄). As such, dispensers 12, 12′, A, B are included in sub-set 36 and discrete positions (R_{A}, C₃), (R_{A}, C₄) are included in sub-set 40. Dispensers 12, 12′, C, D will not be actuated (N/A, which may be a code provided by and recognized by the computer readable product) during step 1, and thus nothing will be dispensed from these particular dispensers 12, 12′, C, D when this step of the addressing scheme is performed. In the example shown in FIG. 3C, the user has also requested that the first addressing scheme finish dispensing to row R_{A} by dispensing 10 μL of a corresponding fluid/substance from dispenser C, 12, 12′ into discrete position (R_{A}, C₁) while simultaneously dispensing 25 μL of a corresponding fluid/substance from dispenser D, 12, 12′ into discrete position (R_{A}, C₂). As such, dispensers 12, 12′, C, D are included in sub-set 38 and discrete positions (R_{A}, CO, (R_{A}, C₂) are included in sub-set 40. Dispensers 12, 12′, A, B will not be actuated (N/A) during step 2, and thus nothing will be dispensed from these particular dispensers 12, 12′, A, B at this point.

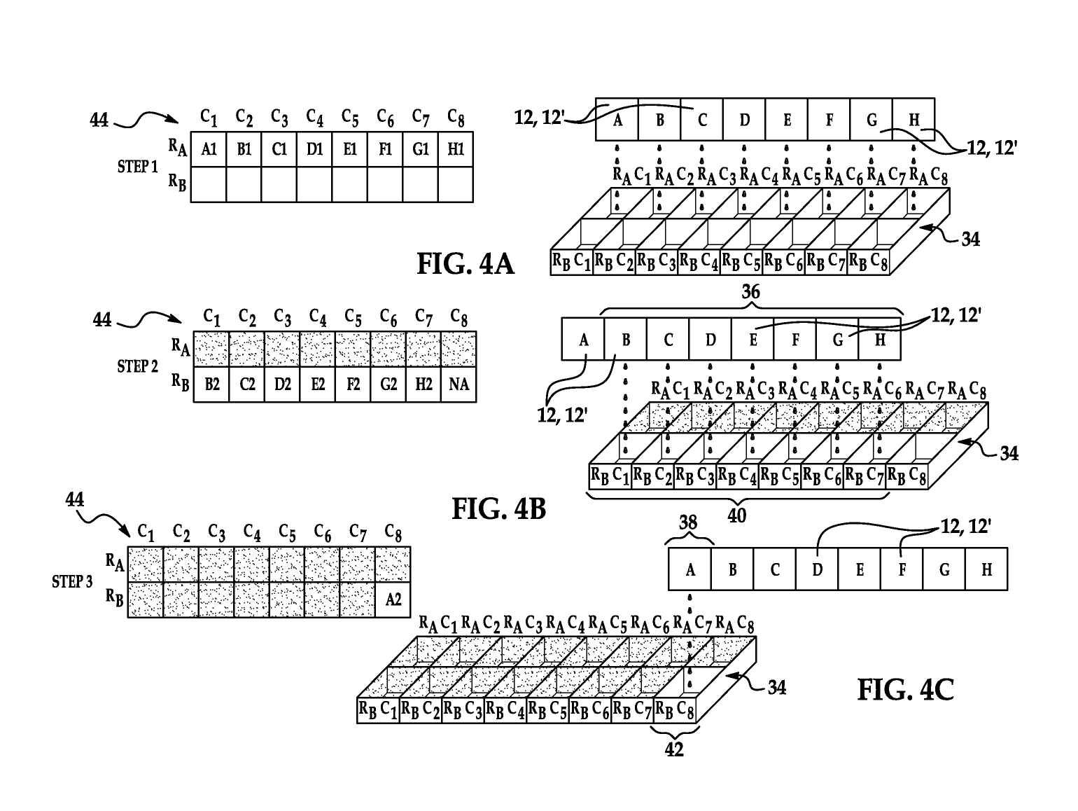

As mentioned above, the user also requested that row R_{B} contain no fluids/substances after the addressing scheme is complete. In other words, the user requests that row R_{B} be bypassed. As shown in FIG. 3C, the computer program product automatically inputs this bypass information, and during dispensing, row R_{B} will be passed over so that nothing is dispensed therein. While not shown in this example, it is to be understood that an individual discrete position may also be bypassed when other discrete positions within the same row are filled (see, e.g., FIGS. 4A-4C).

In the example of FIG. 3C, the user has also requested that the second addressing scheme initially dispense to row R_{C} by first dispensing 100 μL of a corresponding fluid/substance from dispenser B, 12, 12′ into discrete position (R_{C}, C₁) while simultaneously dispensing 100 μL of a corresponding fluid/substance from dispenser C, 12, 12′ into discrete position (R_{C}, C₂) and simultaneously dispensing 100 μL of a corresponding fluid/substance from dispenser D, 12, 12′ into discrete position (R_{C}, C₃). As such, dispenser 12, 12′, B, C, D are included in sub-set 36 and discrete positions (R_{C}, C₁), (R_{C}, C₂) and (R_{C}, C₃) are included in sub-set 40. Dispenser 12, 12′, A will not be actuated (N/A) during step 3, and thus nothing will be dispensed from this particular dispenser 12, 12′, A when this step of the addressing scheme is performed. In the example shown in FIG. 3C, the user has also requested that the second addressing scheme finish dispensing to row R_{C} by dispensing 100 μL of a corresponding fluid/substance from dispenser A, 12, 12′ into discrete position (R_{C}, C₄). This is shown in step 4 (i.e., the second step of the second wrap-around addressing scheme). As such, dispenser 12, 12′, A is included in sub-set 38 and discrete position (R_{C}, C₄) is included in sub-set 40. Dispensers 12, 12′, B, C, D will not be actuated (N/A) during step 4, and thus nothing will be dispensed from these particular dispensers 12, 12′, B, C, D when this step of the addressing scheme is performed.

It is to be understood that the computer program product may be programmed to insert data, such as “complete” or the previously assigned dispensing amounts, when fields of the input table 46 have been filled in earlier steps of the addressing scheme. For example, steps 1 and 2 involve dispensing into row R_{A} and therefore at steps 3 and 4, the fields associated with the dispenser at discrete positions (R_{A}, C₁), (R_{A}, C₂), (R_{A}, C₃) and (R_{A}, C₄) may state complete, at least in part because the dispensing to this row R_{A} is (or will be) completed by steps 3 and 4. Similarly, the fields associated with the amount at discrete positions (R_{A}, C₁), (R_{A}, C₂), (R_{A}, C₃) and (R_{A}, C₄) in steps 3 and 4 may state complete or may alternatively recite the amount that is scheduled to be dispensed into that particular discrete position R_{A}, C₁), (R_{A}, C₂), (R_{A}, C₃) and (R_{A}, C₄).

After the user inputs the desired data/information, the computer program product may generate a layout 44 based upon the completed input table 46. As mentioned above, an example of the layout 44 corresponding to the input table 46 shown in FIG. 3C is shown in FIG. 3A. The layout 44 illustrates, at each step of the overall addressing scheme, which row R_{A}, R_{B}, or R_{C} will be filled, and which dispenser(s) A, B, C, or D will be aligned (and ultimately actuated) with which discrete position(s) in the row. For the wrap-around addressing schemes, the layout 44 can also illustrate which dispensers will not be aligned/addressed/actuated (i.e., those labeled NA). In this example, the number associated with a particular dispenser denotes that the dispensing that will take place at the corresponding discrete position is in accordance with a particular addressing scheme. For example, A1 denotes that the dispenser 12, A will be aligned with discrete position (R_{A}, C₃) when step 1 is performed, and also that dispensing will be in accordance with the first wrap-around addressing scheme as set forth in the input table 46. It is to be understood that the computer program product may also be programmed so that the number associated with a particular dispenser 12, 12′ reflects the actual amount and/or substance to be dispensed (e.g., B1 in step 1 could read “B: 7-25 nL”), a particular dose number in a series of doses that will be dispensed, or the like.

The layout 44 may also include a key to facilitate understanding of the layout 44, and to pictorially represent what will happen at each step of the overall addressing scheme. For example, after a discrete position has been set for filling or partial filling, the representation of that particular discrete position may be colored, contain a pattern, etc. (see, for example, steps 2, 3 and 4). It is believed that this may assist the user in checking that the addressing scheme as presented in the layout 44 actually reflects his/her intentions for dispensing.

Referring now to FIGS. 4A through 40, another example of a layout 44 is depicted. The layout 44 is divided among the three figures by the steps (1, 2 and 3) of the addressing scheme. The respective figures also illustrate the corresponding dispensing scheme (e.g., when the addressing scheme is actually commenced) that takes place at each step of this example in accordance with the addressing scheme set forth in the layout 44. As shown in each of FIGS. 4A through 40, the multi-channel dispenser system 10 includes eight parallel dispensers 12, 12′, A-H and the receiver 34 includes 2 rows R_{A}, R_{B} and 8 columns C₁, C₂, C₃, C₄, C₅, C₆, C₇, C₈, for a total of 16 discrete positions ((R_{A}, C₁), (R_{A}, C₂) . . . (R_{B}, C₁) . . . (R_{C}, C₃) . . . (R_{B}, C₈)).

FIG. 4A illustrates the first step, which is a single addressing scheme. During execution of the single addressing scheme, all of the dispensers 12, 12′, A-H are simultaneously addressed so that each dispenser 12, 12′, A-H dispenses into an aligned discrete position (R_{A}, C₁), (R_{A}, C₂), (R_{A}, C₃), (R_{A}, C₄), (R_{A}, C₅), R_{A}, C₆), (R_{A}, C₇), (R_{A}, C_{B}). As shown in the layout 44 for step 1, each dispenser 12, 12′, A-H is set to be aligned with a respective one of the discrete positions along the first row R_{A}. As shown in the corresponding dispensing scheme, when the addressing scheme is underway, the dispensers 12, 12′, A-H are aligned and dispensing into the respective discrete positions of the receiver 34. In an example, aligning the dispensers 12, 12′ occurs simultaneously, and then dispensing occurs simultaneously.

As briefly mentioned above, when creating the layout 44, a user may desire that fluids/substances be dispensed according to a dosing sequence. The sequence may be set while the user creates the layout 44. The sequence may, for example include a different dose for each row, where the amount dispensed into each discrete position within a single row is the same, but each row corresponds with a different dosage. This type of sequence is illustrated in FIGS. 4A-4C, where 1 represents the dosage for fluids/substances dispensed into row R_{A} and 2 represents the dosage for fluids/substances dispensed into row R_{B}. The sequence may also be particular to the fluid/substance that is to be dispensed. As examples, the fluid/substance dispensed from dispenser 12, 12′, A may be increased by 5 μL for each row in the receiver 34, while the fluid/substance dispensed from dispenser 12, 12′, B may be increased by 50 μL for each row in the receiver 34, and while the fluid/substance dispensed from dispenser 12, 12′, C may be doubled from the amount dispensed in the previous row of the receiver. Table 1 illustrates examples of these sequences.

TABLE 1
Example Dosage Sequences

| | A | B | C |
|---|---|---|---|
| R_{A} | 10 pL | 50 pL | 250 nL |
| R_{B} | 15 pL | 100 pL | 500 nL |

It is to be understood that other, more randomized sequences may be created.

FIGS. 4B and 4C respectively illustrate the second and third steps, which together are a wrap-around addressing scheme for filling/partially filling the discrete positions within row R_{B}. The portion of the layout 44 for each of these steps, 2 and 3, illustrates that row R_{A} has already been set to be filled/partially filled.

At the second step of this example addressing scheme (FIG. 4B), the wrap-around scheme is initiated. As shown in this portion of the layout 44, the user has selected dispensers 12, 12′, B-H as the sub-set 36 to align with the sub-set 40 including discrete positions (R_{B}, C₁), (R_{B}, C₂), (R_{B}, C₃), (R_{B}, C₄), (R_{B}, C₅), (R_{B}, C₆), (R_{B}, C₇). As shown in the corresponding dispensing scheme, the sub-set 36 of dispensers 12, 12′, B-H is positioned so that a fluid/substance associated with each of the dispensers 12, B-H is capable of being dispensed from each of the dispensers 12, 12′, B-H into the user defined discrete position (R_{B}, C₁), (R_{B}, C₂), (R_{B}, C₃), (R_{B}, C₄), (R_{B}, C₆), (R_{B}, C₆), (R_{B}, C₇). As shown in FIG. 4B, the dispenser 12, 12′, A is not set to be part of the sub-set 36, is not to be actuated during this step, and thus does not need to be in registry/alignment with any of the discrete positions in row R_{B}.

At the third step of this example addressing scheme (FIG. 40), the wrap-around scheme is finished. As shown in this portion of the layout 44, the user has selected dispenser 12, 12′, A as the sub-set 38 to align with the sub-set 42 including discrete position (R_{B}, C₈). As shown in the corresponding dispensing scheme, the sub-set 38, including dispenser 12, 12′, A, is positioned so that a fluid/substance associated with the dispenser 12, 12′, A is capable of being dispensed from the dispenser 12, 12′, A into the user defined discrete position (R_{B}, C₈). As shown in FIG. 40, the other dispensers 12, 12′, B-H are not set to be part of the sub-set 38, are not to be actuated during this step, and thus are not in registry/alignment with any of the discrete positions in row R_{B}. It is to be understood that in this example, steps 3 and 2 may be reversed so that dispenser 12, 12′, A is actuated first and then the dispensers 12, 12′, A-H are repositioned so that dispensers 12, 12′, B-H are actuated second.

Referring now to FIG. 5, another example of a layout 44 generated via the computer program product is disclosed herein. This example of the layout 44 illustrates various schemes within the overall addressing scheme, including a single addressing scheme in row R_{A}, wrap-around dispensing schemes in rows R_{B}-R_{H}, and a bypass scheme in row R_{H}. This example of the layout 44 illustrates eight dispensers 12, 12′, A-H and eight dosing sequences 1-8 (which may or may not be sequential, e.g., smallest to largest). Within any given discrete position along the layout 44, a dispenser 12, 12′, A-H is selected and a particular dosing sequence is also selected. When the addressing scheme of this layout 44 is performed via the multi-channel dispenser system 10, the processor 26 will command the appropriate dispenser(s) 12, 12′ to dispense appropriate amounts to the appropriate discrete portions in accordance with the data in the layout 44. As illustrated, the dosing sequence appears random across the layout 44, but is set by the user when creating the layout 44 and thus is really non-random. In another example, the user and/or processor-executed software/computer readable instructions may employ random inputs in defining the layouts 44, including dosages.

For row R_{A}, a single addressing scheme is set in which all of the dispensers 12, 12′, A-H are set to be simultaneously addressed so that each dispenser 12, 12′, A-H dispenses into an aligned discrete position (R_{A}, CO, (R_{A}, C₂), (R_{A}, C₃), (R_{A}, C₄), (R_{A}, C₅), (R_{A}, C₆), (R_{A}, C₇), (R_{A}, C₁).

For row R_{B}, a wrap-around addressing scheme is set in which the first dispenser sub-set 36 includes dispensers 12, 12′, A-D and the corresponding first discrete position sub-set 40 includes discrete positions (R_{B}, C₅), (R_{B}, C₆), (R_{B}, C₇), (R_{B}, C₈). To finish the wrap-around addressing scheme for row R_{B}, the second dispenser sub-set 38 is set to include dispensers 12, 12′, E-H and the corresponding second discrete position sub-set 42 includes discrete positions (R_{B}, C₁), (R_{B}, C₂), (R_{B}, C₃), (R_{B}, C₄). Dosing sequence number 6 is dispensed along row R_{B}.

For row R_{D}, another wrap-around addressing scheme is set. In this wrap-around addressing scheme, the first dispenser sub-set 36 is set to include dispensers 12, 12′, A-F and the corresponding first discrete position sub-set 40 is set to include discrete positions (R_{C}, C₃), (R_{C}, C₄), (R_{C}, C₅), (R_{C}, C₆), (R_{C}, C₇), (R_{C}, C₈). To finish the wrap-around addressing scheme for row R_{D}, the second dispenser sub-set 38 is set to include dispensers 12, 12′, G-H, and the corresponding second discrete position sub-set 42 includes discrete positions (R_{C}, C₁), (R_{C}, C₂). Dosing sequence numbers 2 and 7 are dispensed along row R_{C}.

For row R_{D}, yet another wrap-around addressing scheme is set. In this wrap-around addressing scheme, the first dispenser sub-set 36 is set to include dispensers 12, 12′, A-B and the corresponding first discrete position sub-set 40 is set to include discrete positions (R_{D}, C₇), (R_{D}, C₈). To finish the wrap-around addressing scheme for row R_{D}, the second dispenser sub-set 38 is set to include dispensers 12, 12′, C-H, and the corresponding second discrete position sub-set 42 includes discrete positions (R_{D}, C₁), (R_{D}, C₂), (R_{D}, C₃), (R_{D}, C₄), (R_{D}, C₅), (R_{D}, C₆). Dosing sequence numbers 2, 3 and 7 are dispensed along row R_{D}.

For row R_{E}, still another wrap-around addressing scheme is set. In this wrap-around addressing scheme, the first dispenser sub-set 36 is set to include dispenser 12, 12′, A and the corresponding first discrete position sub-set 40 is set to include discrete position (R_{E}, C₈). To finish the wrap-around addressing scheme for row R_{E}, the second dispenser sub-set 38 is set to include dispensers 12, 12′, B-H, and the corresponding second discrete position sub-set 42 includes discrete positions (R_{E}, C₁), (R_{E}, C₂), (R_{E}, C₃), (R_{E}, C₄), (R_{E}, C₅), (R_{E}, C₆ (R_{E}, C₇). Dosing sequence numbers 3, 5 and 7 are dispensed along row R_{E}.

Another wrap-around addressing scheme is set for row R_{F}. In this wrap-around addressing scheme, the first dispenser sub-set 36 is set to include dispensers 12, 12′, A-G and the corresponding first discrete position sub-set 40 is set to include discrete positions (R_{F}, C₂), (R_{F}, C₃), (R_{F}, C₄), (R_{F}, C₅), (R_{F}, C₆), (R_{F}, C₇), (R_{F}, C₈). To finish the wrap-around addressing scheme for row R_{F}, the second dispenser sub-set 38 is set to include dispenser 12, 12′, H, and the corresponding second discrete position sub-set 42 includes discrete position (R_{F}, CO. Dosing sequence numbers 3 and 5 are dispensed along row R_{F}.

Still another wrap-around addressing scheme is set for row R_{G}. In this wrap-around addressing scheme, the first dispenser sub-set 36 is set to include dispensers 12, 12′, A-E and the corresponding first discrete position sub-set 40 is set to include discrete positions (R_{G}, C₄), (R_{G}, C₅), (R_{G}, C₆), (R_{G}, C₇), (R_{G}, C₈). To finish the wrap-around addressing scheme for row R_{G}, the second dispenser sub-set 38 is set to include dispenser 12, 12′, F-H, and the corresponding second discrete position sub-set 42 includes discrete positions (R_{G}, C₁), (R_{G}, C₂), (R_{G}, C₃). Dosing sequence number 4 is dispensed along row R_{F}.

For row R_{H}, a wrap-around addressing scheme is set and also includes a bypass scheme. The bypass scheme in this example involves bypassing a single discrete position (R_{H}, C₆) while the first sub-set 36 of dispensers is actuated. In this example, the first dispenser sub-set 36 is set to include dispensers 12, 12′, A-C and the corresponding first discrete position sub-set 40 is set to include discrete positions (R_{H}, C₆), (R_{H}, C₇), (R_{H}, C₈). Since dispenser 12, 12′, A is set to be bypassed, when the first sub-set 36 is actuated, dispenser 12, 12′, A will not be actuated while dispensers 12, 12′, B-C will be actuated. As such, when the first step of the wrap-around scheme for row R_{H} is complete, discrete position (R_{H}, C₆) will remain unfilled while discrete positions (R_{H}, C₇), (R_{H}, C₈) will be filled/partially filled according to the dosing sequence number 8. To finish the wrap-around addressing scheme for row R_{G}, the second dispenser sub-set 38 is set to include dispensers 12, 12′, D-H, and the corresponding second discrete position sub-set 42 includes discrete position (R_{H}, C₁), (R_{H}, C₂), (R_{H}, C₃), (R_{H}, C₄), (R_{H}, C₅). Dosing sequence number 8 is dispensed along row R_{F}, except that the fluid/substance associated with dispenser 12, 12′, A is not dispensed in this example due to the bypass scheme that is set by the user.

Rows Rᵢ and Rⱼ in this example are positive and negative control discrete positions. The introduction of the positive signs (+) and negative signs (−) into the layout 44 indicate to the processor 26 that these positions are to be bypassed during the addressing scheme. Individual discrete positions or entire rows and/or columns may also be bypassed for other reasons too, such as, for example, to avoid dispensing a fluid above a known limit of its toxicity or solubility, for example.

While not shown in FIGS. 2-5, it is to be understood that the receiver 34 may include discrete positions 32ₐ-32ₕ or (Rₓ, C_{y}) that are not aligned with a respective one of the dispensers 12, 12′ A-H during one or each step of a wrap-around addressing scheme. For example, the dispensers 12, 12′ may be pipettes whose nozzles are positioned 9 millimeters (mm) apart, and the receiver 34 may be a well plate including discrete positions 32ₐ-32ₕ or (Rₓ, C_{y}) that are each 4.5 mm wide. In this example, during one step of the wrap-around addressing scheme, every other discrete position 32ₐ-32ₕ or (Rₓ, C_{y}) within the respective sub-sets 40, 42 will be filled when the respective sub-sets 36, 38 are actuated. The wrap-around addressing scheme may be modified to include additional steps so that all of the discrete positions 32ₐ-32ₕ or (Rₓ, C_{y}) are filled/partially filled, or desirable discrete positions 32ₐ-32ₕ or (Rₓ, C_{y}) may remain unfilled.

In another similar example, the dispensers 12, 12′ may be jet dispensers whose associated nozzles are positioned 2.25 mm apart, and the receiver 34 may be a well plate including discrete positions 32ₐ-32ₕ or (Rₓ, C_{y}) every 4.5 mm. In this example, during one step of the wrap-around addressing scheme, every other dispenser 12, 12′ within the respective sub-sets 36, 38 may be actuated such that each discrete position 32ₐ-32ₕ or (Rₓ, C_{y}) within the respective sub-set 40, 42 receives a fluid/substance from one of the aligned dispensers within the respective sub-set 36, 38. Alternatively, all of the dispensers 12, 12′ within the respective sub-sets 36, 38 may be actuated such that each discrete position 32ₐ-32ₕ or (Rₓ, C_{y}) within the respective sub-set 40, 42 receives two fluids/substances from the two dispensers 12 that are aligned therewith. In another example, where registry between dispensers 12, 12′ and receivers 34 is not 1:1, it may be appropriate to shift position slightly in between dispensing from members of a subset 36 or 38. This set of dispensing actuations may still be considered parallel and suitably simultaneous or near-simultaneous. Any of these and other variations intended for present purposes to be legitimate steps in possible wrap-around schemes.

Also while not shown in the figures, it is to be understood that the layout 44 can include row (and/or column) hopping, where the rows (and/or columns) are not fulfilled sequentially from row R_{A} (column 1) to row R_{B} (column 2) to row R_{C} (column 3), etc. to the end of the rows (and/or columns). Rather, the computer program product may be used to create a layout 44 where row R_{B} is dispensed first, row R_{A} is dispensed third, etc.

The examples of the computer program product disclosed herein enable the generation and execution of multiple addressing and dispensing schemes. More particularly, the wrap-around addressing schemes allow for flexible experimental designs and dispensing schemes. For example, a layout 44 may be generated that is randomized (e.g., with regard to where certain fluids/substances are dispensed and/or how much volume of fluid is dispensed) across a receiver 34 without loss of parallel dispensing and/or throughput. The layouts 44 may also be customized, including single addressing scheme(s), wrap-around addressing scheme(s), and/or by-pass addressing schemes.

The programming of wrap-around schemes may be automated, such as involving random or systematic allocation of volumes and also random or systematic wrap-around layouts. As such, the wrap-around schemes disclosed herein may be standardized to suit the needs of a given experiment or organization. As examples, standard control wells may be declared for wrap-around in bypass mode; standard layouts may be declared where the first dispenser 12, 12′, A is aligned to a discrete position that is incrementally indexed +3 column locations with each incremental row; a corresponding wrap-around dispensing scheme in two-steps is employed; volumes delivered by each dispenser 12, 12′ at each of its locations are allocated randomly from a list of required volumes; or the like. Advantages of such automation and standardization of layouts 44 with sets of wrap-around schemes include facilitating programming, dispensing speed, and standardized data treatment. Additionally, more sophisticated layouts and experiments can be designed to facilitate cost savings and more valuable discoveries.

Additionally, the wrap-around schemes provide rapid dispensing. Some dispensed components and/or bioassay constituents are sensitive to temperature, and thus prolonged dispensing time may produce undesirable reactions and/or artifacts. Moreover, other inevitable, undesirable artifacts (e.g., temperature bias from edge to center of receiver 34, also known as “edge effects” in well plates) may be accommodated better by using the wrap-around schemes disclosed herein to decouple such artifacts from other variations of interest (bioassay response to different drugs and doses), which ultimately improves research quality. The examples disclosed herein enable rapid dispensing and high throughput that decouples these undesirable reactions and/or artifacts from the dispensing process and its intended and/or unintended consequences. Without the wrap-around schemes, all these artifacts and dispensing consequences could be coupled together, thus degrading the quality of results. Compared with conventional dispensing layouts, the wrap-around schemes disclosed herein retain high throughput and conserve cost while improving the quality of dispensing-based results.

It is to be understood that the ranges provided herein include the stated range and any value or sub-range within the stated range. For example, an amount ranging from about 1 μL to about 5 μL should be interpreted to include not only the explicitly recited amount limits of 1 μL to about 5 μL, but also to include individual amounts, such as 100 μL, 5,000 μL, 0.25 μL, etc., and sub-ranges, such as 50 μL to 1 μL, etc. Furthermore, when “about” is utilized to describe a value, this is meant to encompass minor variations (up to +/−5%) from the stated value.

It is to be understood use of the words “a” and “an” and other singular referents include plural as well, both in the specification and claims.

While several examples have been described in detail, it will be apparent to those skilled in the art that the disclosed examples may be modified. Therefore, the foregoing description is to be considered non-limiting.

What is claimed is:

1. A computer program product comprising a non-transitory, tangible computer readable storage medium having computer readable instructions embodied therewith, the computer readable instructions, when executed by a processor of a multi-channel dispenser system, cause the processor to:
selectively address, according to a wrap-around addressing scheme, a first sub-set of the plurality of dispensers for parallel addressing of the first sub-set adjacent to a first area of a row; and
then selectively address, according to the wrap-around addressing scheme, a second sub-set of the plurality of dispensers that is different from the first sub-set for parallel addressing of the second sub-set adjacent to a second area of the same row that is different than the first area.

2. The computer program product as defined in claim 1 wherein the computer readable instructions further cause the processor to:
initiate a second wrap-around addressing scheme;
selectively address, according to the second wrap-around addressing scheme, a third sub-set of the plurality of dispensers for parallel addressing of the third sub-set adjacent to a first area of a second row; and
then selectively address, according to the second wrap-around addressing scheme, a fourth sub-set of the plurality of dispensers that is different from the third sub-set for parallel addressing of the fourth sub-set adjacent to a second area of the second row that is different from the first area of the second row.

3. The computer program product as defined in claim 1 wherein the computer readable instructions further cause the processor to:
selectively actuate the first sub-set of the plurality of dispensers for parallel dispensing from the first sub-set to the first area of the row, which is part of a receiver; and
then selectively actuate the second sub-set of the plurality of dispensers for parallel dispensing from the second sub-set to the second area of the same row.

4. The computer program product as defined in claim 1 wherein the computer readable instructions further cause the processor to:
initiate a second wrap-around addressing scheme;
selectively address, according to the second wrap-around addressing scheme, a third sub-set of the plurality of dispensers for parallel addressing of the third sub-set adjacent to a third area of the row; and
then selectively address, according to the second wrap-around addressing scheme, a fourth sub-set of the plurality of dispensers that is different from the third sub-set for parallel addressing of the fourth sub-set adjacent to a fourth area of the row that is different from the third area of the row.

5. The computer program product as defined in claim 1 wherein the computer readable instructions further command the processor to perform a bypass scheme where at least some discrete positions of the row or at least some discrete positions of an other row are bypassed.

6. The computer program product as defined in claim 1 wherein the computer readable instructions further command the processor to dispense a substance from at least one of the plurality of dispensers according to a variable dosage sequence that i) has a random appearance, ii) includes different dispensed volumes, or iii) both i and ii.

7. A multi-channel dispenser system, comprising:
a plurality of conjoined dispensers; and
a control interface to receive and execute computer readable instructions embodied on a non-transitory, tangible computer readable storage medium, the instructions to command the control interface to:
initiate a wrap-around dispensing scheme;
selectively actuate, according to the wrap-around dispensing scheme, a first sub-set of the plurality of dispensers for parallel dispensing in a first area of a row; and
then selectively actuate, according to the wrap-around dispensing scheme, a second sub-set of the plurality of dispensers that is different from the first sub-set for parallel dispensing in a second area of the same row that is different from the first area.

8. The multi-channel dispenser system as defined in claim 7, further comprising a receiver that includes:
the row; and
a plurality of discrete positions defined within the row, each of the plurality of discrete positions to receive a substance from a pre-determined one of the plurality of dispensers.

9. The multi-channel dispenser system as defined in claim 8 wherein the row is a first of at least two rows of the receiver, and wherein the computer readable instructions further command the control interface to:
initiate a second wrap-around dispensing scheme;
selectively actuate, according to the second wrap-around dispensing scheme, a third sub-set of the plurality of dispensers for parallel dispensing in i) a first area of a second of the at least two rows or ii) a third area of the first of the at least two rows; and
then selectively actuate, according to the second wrap-around dispensing scheme, a fourth sub-set of the plurality of dispensers that is different from the third sub-set for parallel dispensing in i) a second area of the second of the at least two rows that is different from the first area of the second of the at least two rows or ii) a fourth area of the first of the at least two rows that is different from the third area of the first of the at least two rows.

10. The multi-channel dispenser system as defined in claim 8 wherein the row is a first of at least two rows of the receiver, and wherein the computer readable instructions further command the control interface to actuate all of the plurality of dispensers simultaneously for parallel dispensing into each of a plurality of discrete positions defined within a second of the at least two rows.

11. The multi-channel dispenser system as defined in claim 8 wherein the receiver includes a plurality of rows and wherein the computer readable instructions further command the control interface to parallel dispense according to a different wrap-around dispensing scheme for each of the plurality of rows.

12. The multi-channel dispenser system as defined in claim 7 wherein the plurality of conjoined dispensers is chosen from thermal jet dispensers, piezo jet dispensers, piezo-capillary jet dispensers, acoustic dispensers, tips, and pipettors.

13. The multi-channel dispenser system as defined in claim 7 wherein the plurality of conjoined dispensers include conjoined dispenser heads or conjoined nozzles.

14. A parallel addressing method, comprising:
selectively addressing, according to a wrap-around addressing scheme, a first sub-set of a plurality of dispensers for parallel addressing of the first sub-set adjacent to a first area of a row; and
then selectively address, according to the wrap-around addressing scheme, a second sub-set of the plurality of dispensers that is different from the first sub-set for parallel addressing of the second sub-set adjacent to a second area of the same row that is different than the first area.

15. The parallel addressing method as defined in claim 14, further comprising:
selectively addressing, according to a second wrap-around addressing scheme, a third sub-set of the plurality of dispensers for parallel addressing of the third sub-set adjacent to i) a first area of a second row that is different from the row or ii) a third area of the row; and
then selectively addressing, according to the second wrap-around addressing scheme, a fourth sub-set of the plurality of dispensers that is different from the third sub-set for parallel addressing of the fourth sub-set adjacent to i) a second area of the second row that is different from the first area of the second row or ii) a fourth area of the row that is different from the third area of the row.

16. The parallel addressing method as defined in claim 14, further comprising performing multiple wrap-around schemes to dispense drugs at doses corresponding to a titration series.
